(19) United States
(12) Patent Application Publication
(10) Pub. No.: US 2026/0202249 A1
(43) Pub. Date: Jul. 16, 2026

(54) IMAGING SYSTEM INCLUDING A VARIABLE-THICKNESS DETECTOR

(71) Applicant: Raytheon Company, Arlington, VA (US)

(72) Inventors: Jamal I. Mustafa, Goleta, CA (US); Richard J. Peralta, Santa Barbara, CA (US); John L. Vampola, Tuscola, TX (US)

(21) Appl. No.: 19/024,499

(22) Filed: Jan. 16, 2025

(51) Int. Cl. G01J 3/28; G01B 11/06

(52) U.S. Cl. CPC G01J 3/2823; G01B 11/06; G01J 2003/2826

(57) ABSTRACT

An imaging system includes a variable-thickness detector and a spectral band filter. The variable-thickness detector includes a plurality of regions, and the spectral band filter includes a plurality of band sections. Each of the band sections is configured to transmit electromagnetic waves within a specified range of wavelengths. The imaging system is configured to align each of the plurality of regions with a corresponding band section based on a thickness of the region and the specified range of wavelengths for the corresponding band section.

### TECHNICAL FIELD

This disclosure relates generally to imaging systems and processes. More specifically, this disclosure relates to an imaging system including a variable-thickness detector.

### BACKGROUND

Conventional imaging systems include detectors that may be designed in order to optimize sensor parameters, such as quantum efficiency (QE) and modulation transfer function (MTF), in addition to other parameters. However, optimizing both QE and MTF together is challenging as they depend oppositely on detector thickness. Thicker detectors have higher QE at longer wavelengths, while thinner detectors have improved MTF values at shorter wavelengths. Because of this, imaging systems are typically designed to be optimized for detecting either longer wavelengths by using a thicker detector or shorter wavelengths by using a thinner detector. As a result, these detectors cannot simultaneously achieve both high QE and good MTF values across multiple spectral bands.

### SUMMARY

This disclosure relates to an imaging system including a variable-thickness detector.

In a first embodiment, an imaging system may include a variable-thickness detector and a spectral band filter. The variable-thickness detector may include a plurality of regions, and the spectral band filter may include a plurality of band sections. Each of the band sections may be configured to transmit electromagnetic waves within a specified range of wavelengths. The imaging system may be configured to align each of the plurality of regions with a corresponding band section based on a thickness of the region and the specified range of wavelengths for the corresponding band section.

Any single one or any combination of the following features may be used with the first embodiment. A thinnest region may be aligned with the band section configured to transmit the specified range of wavelengths that includes shortest wavelengths, and a thickest region may be aligned with the band section configured to transmit the specified range of wavelengths that includes longest wavelengths. The imaging system can include a sensor that includes the variable-thickness detector and a read-out integrated circuit. The variable-thickness detector may be configured to detect image data, and the read-out integrated circuit may be configured to receive the image data from the variable-thickness detector and to generate an output based on the image data. The imaging system may be configured to generate an image based on the output generated by the read-out integrated circuit. The variable-thickness detector may be hybridized to the read-out integrated circuit. The variable-thickness detector may include one of a wedge shape, a stepped shape or a combination thereof. The spectral band filter may include a butcher block filter. The imaging system may include a shim configured to position the sensor such that a distance between the sensor and the spectral band filter is substantially consistent across a surface of the variable-thickness detector. The sensor may be coupled to the shim. The imaging system may be included as part of a flight vehicle or a space vehicle.

In a second embodiment, an imaging system may include a variable-thickness detector and a spectral band filter. The variable-thickness detector may include a plurality of regions. The variable-thickness detector may have a wedge shape including a corresponding thickness gradient such that a thickness of the variable-thickness detector transitions substantially continuously from a thinnest region of the variable-thickness detector to a thickest region of the variable-thickness detector. The spectral band filter may include a plurality of band sections. Each of the band sections may be configured to transmit electromagnetic waves within a specified range of wavelengths. The imaging system may be configured to align each of the plurality of regions of the variable-thickness detector with a corresponding band section based on a thickness of the region and the specified range of wavelengths for the corresponding band section.

Any single one or any combination of the following features may be used with the second embodiment. The thinnest region may be aligned with the band section configured to transmit the specified range of wavelengths that includes shortest wavelengths, and the thickest region may be aligned with the band section configured to transmit the specified range of wavelengths that includes longest wavelengths. The imaging system can include a sensor that includes the variable-thickness detector and a read-out integrated circuit. The variable-thickness detector may be configured to detect image data, and the read-out integrated circuit may be configured to receive the image data from the variable-thickness detector and to generate an output based on the image data. The imaging system may be configured to generate an image based on the output generated by the read-out integrated circuit. The variable-thickness detector may be hybridized to the read-out integrated circuit. The spectral band filter may include a butcher block filter. The imaging system may include a shim configured to position the sensor such that a distance between the sensor and the spectral band filter is substantially consistent across a surface of the variable-thickness detector. The sensor may be coupled to the shim. The imaging system may be included as part of a flight vehicle or a space vehicle.

In a third embodiment, an imaging system may include a variable-thickness detector and a spectral band filter. The variable-thickness detector may include a plurality of steps. Each of the steps may have a corresponding thickness. The spectral band filter may include a plurality of band sections. Each of the band sections may be configured to transmit electromagnetic waves within a specified range of wavelengths. The imaging system may be configured to align each of the plurality of steps with a corresponding band section based on a thickness of the step and the specified range of wavelengths for the corresponding band section.

Any single one or any combination of the following features may be used with the third embodiment. A thinnest step may be aligned with the band section configured to transmit the specified range of wavelengths that includes shortest wavelengths, and a thickest step may be aligned with the band section configured to transmit the specified range of wavelengths that includes longest wavelengths. The imaging system can include a sensor that includes the variable-thickness detector and a read-out integrated circuit. The variable-thickness detector may be configured to detect image data, and the read-out integrated circuit may be configured to receive the image data from the variable-thickness detector and to generate an output based on the image data. The imaging system may be configured to generate an image based on the output generated by the read-out integrated circuit. The variable-thickness detector may be hybridized to the read-out integrated circuit. The spectral band filter may include a butcher block filter. The imaging system may be included as part of a flight vehicle or a space vehicle.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-C illustrate an example of an imaging system including a variable-thickness detector according to this disclosure;

FIG. 2 illustrates an example of the imaging system of FIG. 1 according to this disclosure;

FIG. 3 illustrates an example of a sensor including a variable-thickness detector according to this disclosure;

FIG. 4 illustrates a graph depicting examples of quantum efficiency for the variable-thickness detector of FIG. 2 or 3 according to this disclosure; and

FIG. 5 illustrates a graph depicting examples of modulation transfer functions for the variable-thickness detector of FIG. 2 or 3 according to this disclosure.

### DETAILED DESCRIPTION

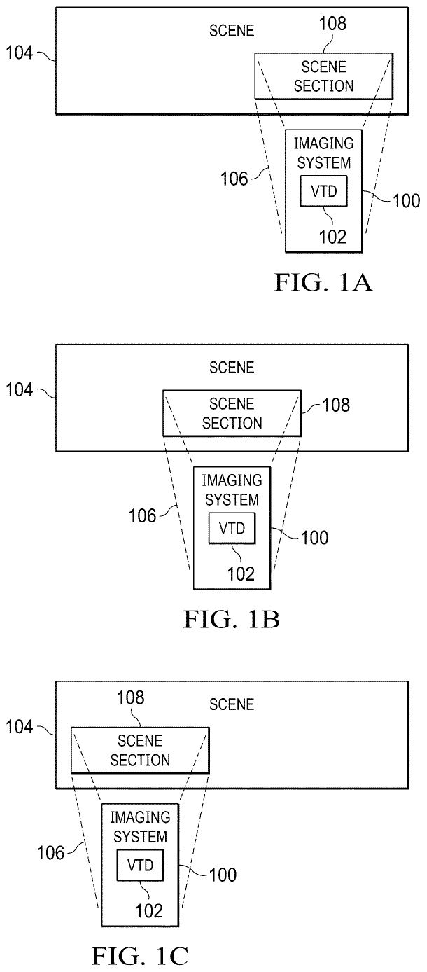

FIGS. 1A through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, conventional imaging systems include detectors that may be designed in order to optimize sensor parameters. For example, these sensor parameters may include quantum efficiency (QE), which is related to the detector's ability to absorb light and efficiently generate and collect carriers. These sensor parameters may also include modulation transfer function (MTF), which is related to the detector's ability to resolve objects (that is, the sharpness and resolution possible for an image generated by the detector). Optimizing both QE and MTF together, however, is challenging as they depend oppositely on detector thickness. Thicker detectors can absorb more light and can have higher QE at longer wavelengths. On the other hand, thicker detectors allow generated carriers to spread out more into neighboring pixels, blurring the image and decreasing MTF. As a result, thinner detectors have improved MTF values, especially at shorter wavelengths. Because of this, imaging systems are typically designed to be optimized for detecting either longer wavelengths by using a thicker detector or shorter wavelengths by using a thinner detector. As a result, these detectors cannot simultaneously achieve both high QE and good MTF values across multiple spectral bands.

This disclosure provides various imaging systems that include variable-thickness detectors and spectral band filters. In each imaging system, the variable-thickness detector includes a plurality of regions, and the spectral band filter includes a plurality of band sections. Each of the band sections is configured to transmit electromagnetic waves within a specified range of wavelengths, and the imaging system is configured to align each of the plurality of regions with a corresponding band section based on a thickness of the region and the specified range of wavelengths for the corresponding band section. Thus, longer wavelengths may be detected by a thicker region of the variable-thickness detector to optimize QE, while shorter wavelengths may be detected by a thinner region of the variable-thickness detector to optimize MTF. In this way, QE and MTF may both be optimized together in a detector.

FIGS. 1A-C illustrate an example of an imaging system 100 including a variable-thickness detector (VTD) 102 according to this disclosure. The embodiment of the imaging system 100 shown in FIGS. 1A-C are for illustration only. Other embodiments of the imaging system 100 may be used without departing from the scope of this disclosure.

According to embodiments of this disclosure, the imaging system 100 includes a variable-thickness detector 102 as described in more detail below. The imaging system 100 with the variable-thickness detector 102 can be configured to generate an image of at least a portion of a scene 104. The imaging system 100 may include a field of view 106 such that the imaging system 100 may be configured to generate images of scene sections 108 that correspond to the field of view 106 based on the location of the variable-thickness detector 102 relative to the scene 104. Each scene section 108 can include at least a portion of the entire scene 104. The imaging system 100 can be configured for a wide range of frequencies to meet the needs of any particular imaging application, such as weather, observation, communication, astronomy, reconnaissance, navigation, or the like. As a particular example, the imaging system 100 can be configured to be included as part of any type of space vehicle (such as a satellite or spaceship), flight vehicle (such as a high-altitude or other aircraft), or the like.

As illustrated in FIGS. 1A-C, the imaging system 100 may be configured to move with respect to the scene 104 in order to generate multiple images of multiple scene sections 108 as the imaging system 100 moves across the scene 104. However, in other embodiments, the scene 104 may be configured to move with respect to the imaging system 100. In still other embodiments, the imaging system 100 and the scene 104 may both be configured to move relative to each other, either in different directions or in the same direction (potentially at different speeds).

The imaging system 100 may be configured to generate images of scene sections 108 substantially continuously at any suitable rate based on the application in which the imaging system 100 is implemented. Thus, according to embodiments of this disclosure, the scene sections 108 imaged by the imaging system 100 may include overlapping areas of the scene 104. In this way, the variable-thickness detector 102 may be configured to detect the same area of the scene 104 multiple times as the multiple images are generated. In addition, because of the relative motion between the imaging system 100 and the scene 104, the variable-thickness detector 102 can be located differently with respect to the same area of the scene 104 as each scene section 108 is imaged. Thus, in this way, the variable-thickness detector 102 may be configured as a scanned detector that can image at least a portion of the scene 104 in a particular scan direction. The scan direction can be a direction in which the scene 104 is moving relative to the variable-thickness detector 102, regardless of whether the imaging system 100 is moving, the scene 104 is moving, or the imaging system 100 and the scene 104 are both moving.

As described in more detail below, the variable-thickness detector 102 may be configured to have a thickness gradient in the scan direction such that the thickness is thinner for detecting shorter wavelengths and thicker for detecting longer wavelengths. According to embodiments of this disclosure, the variable-thickness detector 102 may be include a wedge shape, which is configured to provide a substantially continuous thickness gradient. In some embodiments, the wedge shape may be shaped during thinning or in any other suitable manner and may be provided by grinding, polishing and/or etching of the variable-thickness detector 102. According to other embodiments of this disclosure, the variable-thickness detector 102 may be include a stepped shape, which is configured to provide a thickness gradient as a series of discrete steps, each of which has a different height. In some embodiments, the stepped shape may be provided via etching after thinning or in any other suitable manner. The variable-thickness detector 102 can include a charge-coupled device or other suitable image data detection device.

Although FIGS. 1A-C illustrate one example of an imaging system 100 including a variable-thickness detector 102, various changes may be made to FIGS. 1A-C. For instance, the imaging system 100 may include additional components not shown in FIGS. 1A-C. As particular examples, the imaging system 100 can include additional optical or electrical components such as lenses, filters, amplifiers, and controllers. In addition, note that the views shown in FIGS. 1A-C are not to scale.

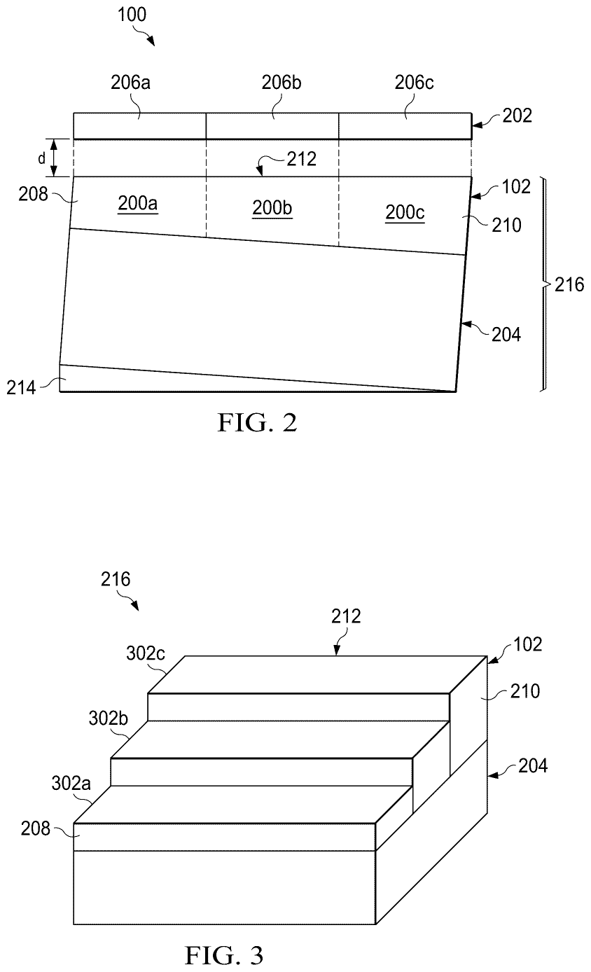

FIG. 2 illustrates an example of the imaging system 100 including the variable-thickness detector 102 according to this disclosure. The embodiment of the imaging system 100 shown in FIG. 2 is for illustration only. Other embodiments of the imaging system 100 may be used without departing from the scope of this disclosure.

According to embodiments of this disclosure, the variable-thickness detector 102 can include a wedge shape as illustrated in FIG. 2. In these embodiments, the variable-thickness detector 102 can include a wedge-shaped device having a substantially continuous thickness gradient. The variable-thickness detector 102 can include multiple regions 200 within the variable-thickness detector 102 as described in more detail below.

According to embodiments of this disclosure, in addition to the variable-thickness detector 102, the imaging system 100 can include a spectral band filter 202 and a read-out integrated circuit 204. The spectral band filter 202 can include a butcher block filter or other suitable device configured to filter electromagnetic waves based on their spectral band. Thus, the spectral band filter 202 can include multiple band sections 206. Each band section 206 can be configured to transmit a specified range of electromagnetic wavelengths and to absorb and/or reflect wavelengths outside the specified range. Although the embodiment illustrated in FIG. 2 includes three band sections 206a-c, it will be understood that the spectral band filter 202 can include any suitable number of band sections 206 based on the application in which the imaging system 100 is implemented.

Each region 200 of the variable-thickness detector 102 can be aligned with a corresponding band section 206 of the spectral band filter 202. As a particular example, in the illustrated embodiment, a first region 200a of the variable-thickness detector 102 can be aligned with a first band section 206a of the spectral band filter 202, while a second region 200b can be aligned with a second band section 206b and a third region 200c can be aligned with a third band section 206c.

The variable-thickness detector 102 can be configured to have a thickness gradient in accordance with the design of the spectral band filter 202. Thus, as a particular example, for embodiments in which the band section 206a can transmit blue light, the thickness of the region 200a that is aligned with the band section 206a can be optimized for detecting blue light. Similarly, for embodiments in which the band section 206b can transmit green light and the band section 206c can transmit red light, the thicknesses of the regions 200b and 200c that are aligned with those band sections 206b and 206c can be optimized for detecting green light and red light, respectively.

Thus, a thinnest region 208 of the variable-thickness detector 102 can be aligned with the band section 206 configured to transmit the shortest wavelengths to be detected, while a thickest region 210 of the variable-thickness detector 102 can be aligned with the band section 206 configured to transmit the longest wavelengths to be detected. In addition, the thickness of the variable-thickness detector 102, including the gradient of the thickness, can be designed based on the particular application in which the variable-thickness detector 102 is to be implemented. In this way, by using a spectral band filter 202 in conjunction with a variable-thickness detector 102, where each region 200 of the variable-thickness detector 102 is sensitive to a specified range of wavelengths based on alignment with a corresponding band section 206, the variable-thickness detector 102 can be designed with a thickness gradient that optimizes both QE and MTF for the variable-thickness detector 102 across multiple spectral bands.

According to some embodiments of this disclosure, in operation, a scene 104 may move relative to a surface 212 of the variable-thickness detector 102. As a particular example, the imaging system 100 can be installed on a satellite orbiting Earth. For this example, in the illustrated embodiment, the first region 200a of the variable-thickness detector 102 detects blue light emitted from a particular piece of the ground. As that piece of ground moves, the second region 200b of the variable-thickness detector 102 detects green light emitted from the same particular piece of ground, followed by the third region 200c of the variable-thickness detector 102 detecting red light emitted from that same particular piece of ground. Thus, the particular piece of ground can be seen by the entire length of the variable-thickness detector 102, with each of a plurality of wavelength ranges emitted from the scene 104 being detected by a corresponding region 200 of the variable-thickness detector 102 that is designed to have a thickness optimized for detecting that range of wavelengths.

In some embodiments, the imaging system 100 can include a sensor 216. The sensor 216 can include the variable-thickness detector 102 hybridized or otherwise coupled to the read-out integrated circuit 204. The read-out integrated circuit 204 can be configured to receive image data detected by the variable-thickness detector 102 and to generate an output based on the image data. In some embodiments, the read-out integrated circuit 204 can be configured to generate the output by processing the image data and outputting the processed image data or by outputting the image data to another component (not illustrated in FIG. 2) for processing. The imaging system 100 can be configured to generate an image of the particular piece of ground based on the output generated by the read-out integrated circuit 204 by combining the image data detected by each of the regions 200 of the variable-thickness detector 102.

According to embodiments of this disclosure, the imaging system 100 can be configured such that a distance, d, between the variable-thickness detector 102 and the spectral band filter 202 is substantially constant across the surface 212 of the variable-thickness detector 102. In some embodiments, for example, the imaging system 100 can include an optional shim 214. The sensor 216 can be coupled to the shim 214 so as to compensate for the wedge shape of the variable-thickness detector 102. The shim 214 can include silicon or any other suitable material.

When included, the shim 214 can be configured to provide a flat surface 212 for electromagnetic waves incident on the variable-thickness detector 102. In this way, the imaging system 100 can be provided with a rectangular shape that can be integrated more easily into a package for some applications as compared to an irregularly-shaped imaging system 100 without the shim 214. However, for some applications in which a rectangular shape is not necessarily desirable, the shim 214 may be omitted. Thus, by including the shim 214, the imaging system 100 can be shaped such that the distance remains substantially constant. However, it will be understood that other arrangements may be implemented to provide a substantially constant distance between the variable-thickness detector 102 and the spectral band filter 202.

Although FIG. 2 illustrates one example of an imaging system 100 including a variable-thickness detector 102, various changes may be made to FIG. 2. For instance, the imaging system 100 may include additional components not shown in FIG. 2. As particular examples, the imaging system 100 can include additional optical or electrical components such as lenses, filters, amplifiers, and controllers. In addition, note that the view shown in FIG. 2 is not to scale.

FIG. 3 illustrates an example of a sensor 216 including the variable-thickness detector 102 according to this disclosure. The embodiment of the sensor 216 shown in FIG. 3 is for illustration only. Other embodiments of the sensor 216 may be used without departing from the scope of this disclosure.

According to embodiments of this disclosure, the variable-thickness detector 102 of the sensor 216 can include a stepped shape as illustrated in FIG. 3, as opposed to the wedge shape as illustrated in FIG. 2. As with the embodiment illustrated in FIG. 2, the stepped-shape variable-thickness detector 102 can be hybridized to the read-out integrated circuit 204. In these embodiments, the variable-thickness detector 102 may be etched or otherwise shaped such that the variable-thickness detector 102 is formed into multiple steps 302a-c of varying heights.

The variable-thickness detector 102 illustrated in FIG. 3 includes a step 302 for each band section 206 of the spectral band filter 202. Thus, in these embodiments, each step 302 corresponds to a region 200 of the variable-thickness detector 102 as described above in connection with FIG. 2. When implemented in the imaging system 100 illustrated in FIG. 2, the variable-thickness detector 102 of FIG. 3 can include a step 302a that is aligned with the band section 206a, a step 302b that is aligned with the band section 206b, and a step 302c that is aligned with the band section 206c.

For the particular embodiment of the spectral band filter 202 illustrated in FIG. 2, the thickness of the step 302a can be optimized for detecting blue light, the thickness of the step 302b can be optimized for detecting green light, and the thickness of the step 302c can be optimized for detecting red light. In addition, the thinnest region 208 of the variable-thickness detector 102 is provided by the shortest step 302a, while the thickest region 210 is provided by the tallest step 302c. As previously described, the spectral band filter 202 can include any suitable number of band sections 206, and thus, according to embodiments of this disclosure, the number of steps 302 included in the variable-thickness detector 102 can be any suitable number based on the number of corresponding band sections 206.

Although FIG. 3 illustrates one example of a portion of a sensor 216 including a variable-thickness detector 102, various changes may be made to FIG. 3. For instance, the sensor 216 may include additional components not shown in FIG. 3. As a particular example, depending on the application and the type of spectral band filter 202 included in the imaging system 100, the variable-thickness detector 102 can include one step 302 for multiple band sections 206 or can include multiple steps 302 for one band section 206. Also, in some embodiments, if the distance between the variable-thickness detector 102 and the spectral band filter 202 is desired to be consistent across the variable-thickness detector 102, a shim 214 may be included to decrease the differences in distances between the band sections 206 and the corresponding steps 302, a step-shaped filter 202 may be included, or any other suitable arrangement may be implemented to decrease the differences in distances between the band sections 206 and the corresponding steps 302. Also, while shown as steadily increasing in height, the steps 302 may be provided in any other suitable height arrangement that is configured to align with the spectral band filter 202, as previously described. Furthermore, the variable-thickness detector 102 can include any other suitable shapes with varying thicknesses other than a wedge shape or a stepped shape. In addition, note that the view shown in FIG. 3 is not to scale.

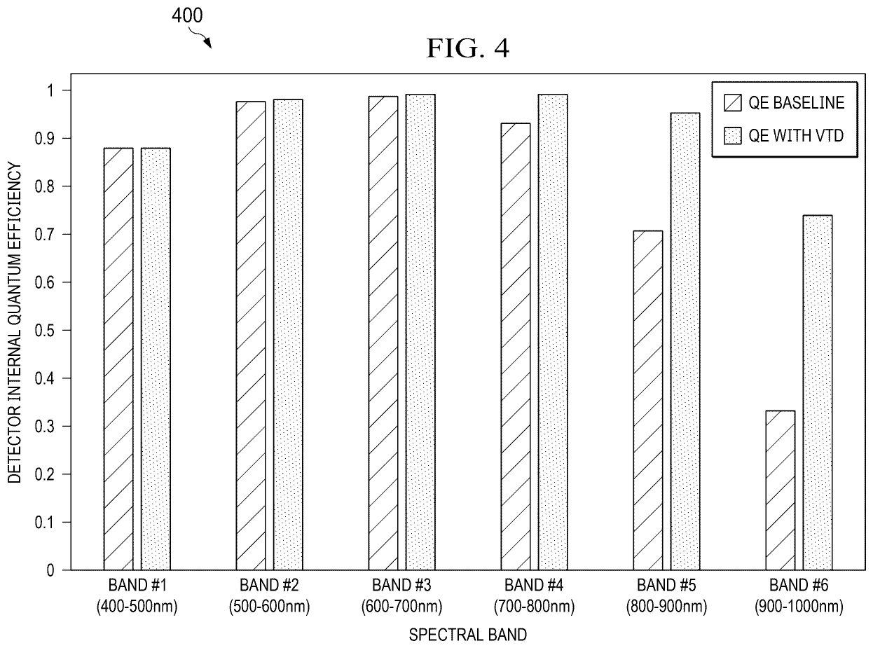

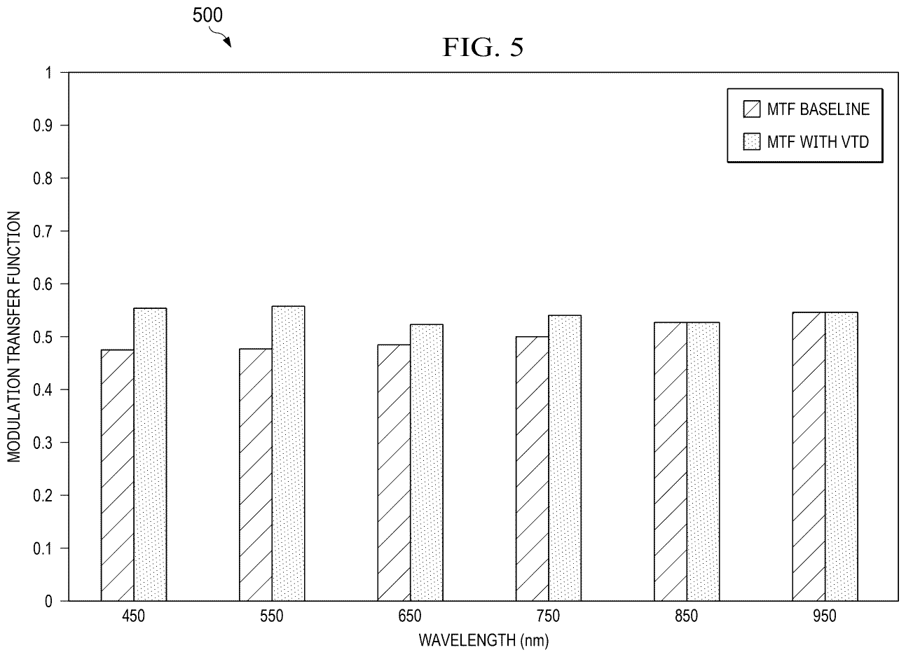

FIG. 4 illustrates a graph 400 depicting examples of quantum efficiency (QE) for the variable-thickness detector 102 according to this disclosure, and FIG. 5 illustrates a graph 500 depicting examples of modulation transfer functions (MTFs) for the variable-thickness detector of 102 according to this disclosure. The examples of QE shown in FIG. 4 and the MTFs shown in FIG. 5 are for illustration only. Different QEs and different MTFs may occur without departing from the scope of this disclosure.

As shown in the graph 400, QE is generally high at shorter wavelengths. However, for those shorter wavelengths, most of the short-wave light gets absorbed near the surface 212 on which it is incident. Because of this, short-wave light generates carriers that have more room to spread out, making MTF worse at shorter wavelengths. Similarly, QE becomes worse when a detector is thinner at longer wavelengths, as shown by the QE Baseline in the graph 400.

The following table shows the baseline thickness for the QE Baseline as compared to the graded thickness for the QE with VTD for the data included in the graph 400:

| Band | Baseline Thickness (μm) | Graded Thickness (μm) |
|---|---|---|
| 1 | 20 | 20 |
| 2 | 20 | 30 |
| 3 | 20 | 40 |
| 4 | 20 | 50 |
| 5 | 20 | 60 |
| 6 | 20 | 80 |

The following table shows the baseline thickness for the MTF Baseline as compared to the graded thickness for the MTF with VTD for the data included in the graph 500:

| Band | Baseline Thickness (μm) | Graded Thickness (μm) |
|---|---|---|
| 1 | 40 | 20 |
| 2 | 40 | 20 |
| 3 | 40 | 30 |
| 4 | 40 | 30 |
| 5 | 40 | 40 |
| 6 | 40 | 40 |

According to embodiments of this disclosure, as shown in the graph 400, a baseline QE can be improved for longer wavelengths by having a thicker region 200 of the variable-thickness detector 102 sensitive to those longer wavelengths. For the illustrated graph 400, the thickness for the baseline QE is optimized for blue MTF, while the thickness gradient of the variable-thickness detector 102 is designed to improve QE for red. Similarly, as shown in the graph 500, a baseline MTF can be improved for shorter wavelengths by having a thinner region 200 of the variable-thickness detector 102 sensitive to those shorter wavelengths. For the illustrated graph 500, the thickness for the baseline MTF is optimized for red QE, while the thickness gradient of the variable-thickness detector 102 is designed to improve MTF for blue.

Thus, to optimize blue MTF, the variable-thickness detector 102 can be relatively thin where the detector 102 is aligned with a band section 206a of the spectral band filter 202 that is configured to transmit blue light, thus allowing for improved MTF at shorter wavelengths. In addition, to optimize red QE, the variable-thickness detector 102 can be relatively thick where the detector 102 is aligned with a band section 206c of the spectral band filter 202 that is configured to transmit red light, thus allowing for improved QE at longer wavelengths as compared to the QE provided by a conventional thin detector. By designing the variable-thickness detector 102 such that the thickness gradient matches the spectral band filter 202, the variable-thickness detector 102 can be configured to be thicker where wavelengths that are longer are received from the spectral band filter 202 on the detector surface 212 and thinner where wavelengths that are shorter are received from the spectral band filter 202 on the detector surface 212.

Although FIG. 4 illustrates examples of QE for the variable-thickness detector 102 and FIG. 5 illustrates examples of MTFs related to the use of a variable-thickness detector 102, various changes may be made to FIGS. 4 and 5. For instance, the actual QEs and MTFs will vary with the specific physical characteristics of the actual variable-thickness detector 102.

It may be advantageous to set forth definitions of certain words and phrases used throughout this patent document. The term “about” (when used with a numerical value) indicates that the numerical value may vary by up to ±10%. The terms “include” and “include,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 114 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 114 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An imaging system comprising:
a variable-thickness detector comprising a plurality of regions; and
a spectral band filter comprising a plurality of band sections;
wherein each of the band sections is configured to transmit electromagnetic waves within a specified range of wavelengths; and
wherein the imaging system is configured to align each of the plurality of regions with a corresponding band section based on a thickness of the region and the specified range of wavelengths for the corresponding band section.

2. The imaging system of claim 1, wherein:
a thinnest region is aligned with the band section configured to transmit the specified range of wavelengths that comprises shortest wavelengths; and
a thickest region is aligned with the band section configured to transmit the specified range of wavelengths that comprises longest wavelengths.

3. The imaging system of claim 1, further comprising a sensor, wherein:
the sensor comprises the variable-thickness detector and a read-out integrated circuit.

4. The imaging system of claim 3, wherein:
the variable-thickness detector is configured to detect image data;
the read-out integrated circuit is configured to receive the image data from the variable-thickness detector and to generate an output based on the image data;
the imaging system is further configured to generate an image based on the output generated by the read-out integrated circuit; and
the variable-thickness detector is hybridized to the read-out integrated circuit.

5. The imaging system of claim 3, further comprising:
a shim configured to position the sensor such that a distance between the sensor and the spectral band filter is substantially consistent across a surface of the variable-thickness detector;
wherein the sensor is coupled to the shim.

6. The imaging system of claim 1, wherein the variable-thickness detector comprises one of a wedge shape, a stepped shape or a combination thereof.

7. The imaging system of claim 1, wherein the spectral band filter comprises a butcher block filter.

8. The imaging system of claim 1, wherein the imaging system is comprised as part of a flight vehicle or a space vehicle.

9. An imaging system comprising:
a variable-thickness detector comprising a plurality of regions, wherein the variable-thickness detector has a wedge shape comprising a corresponding thickness gradient such that a thickness of the variable-thickness detector transitions substantially continuously from a thinnest region of the variable-thickness detector to a thickest region of the variable-thickness detector; and
a spectral band filter comprising a plurality of band sections, wherein each of the band sections is configured to transmit electromagnetic waves within a specified range of wavelengths;
wherein the imaging system is configured to align each of the plurality of regions of the variable-thickness detector with a corresponding band section based on a thickness of the region and the specified range of wavelengths for the corresponding band section.

10. The imaging system of claim 9, wherein:
the thinnest region is aligned with the band section configured to transmit the specified range of wavelengths that comprises shortest wavelengths; and
the thickest region is aligned with the band section configured to transmit the specified range of wavelengths that comprises longest wavelengths.

11. The imaging system of claim 9, further comprising a sensor, wherein:
the sensor comprises the variable-thickness detector and a read-out integrated circuit.

12. The imaging system of claim 11, wherein:
the variable-thickness detector is configured to detect image data;
the read-out integrated circuit is configured to receive the image data from the variable-thickness detector and to generate an output based on the image data;
the imaging system is further configured to generate an image based on the output generated by the read-out integrated circuit; and
the variable-thickness detector is hybridized to the read-out integrated circuit.

13. The imaging system of claim 11, further comprising:
a shim configured to position the sensor such that a distance between the sensor and the spectral band filter is substantially consistent across a surface of the variable-thickness detector;
wherein the sensor is coupled to the shim.

14. The imaging system of claim 9, wherein the spectral band filter comprises a butcher block filter.

15. The imaging system of claim 9, wherein the imaging system is comprised as part of a flight vehicle or a space vehicle.

16. An imaging system comprising:
a variable-thickness detector comprising a plurality of steps, wherein each of the steps has a corresponding thickness; and
a spectral band filter comprising a plurality of band sections, wherein each of the band sections is configured to transmit electromagnetic waves within a specified range of wavelengths;
wherein the imaging system is configured to align each of the plurality of steps with a corresponding band section based on a thickness of the step and the specified range of wavelengths for the corresponding band section.

17. The imaging system of claim 16, wherein:
a thinnest step is aligned with the band section configured to transmit the specified range of wavelengths that comprises shortest wavelengths; and
a thickest step is aligned with the band section configured to transmit the specified range of wavelengths that comprises longest wavelengths.

18. The imaging system of claim 16, further comprising a sensor, wherein:
the sensor comprises the variable-thickness detector and a read-out integrated circuit;
the variable-thickness detector is hybridized to the read-out integrated circuit and is configured to detect image data;
the read-out integrated circuit is configured to receive the image data from the variable-thickness detector and to generate an output based on the image data; and
the imaging system is further configured to generate an image based on the output generated by the read-out integrated circuit.

19. The imaging system of claim 16, wherein the spectral band filter comprises a butcher block filter.

20. The imaging system of claim 16, wherein the imaging system is comprised as part of a flight vehicle or a space vehicle.
